(19) United States
(12) Patent Application Publication
(10) Pub. No.: US 2009/0059019 A1
(43) Pub. Date: Mar. 5, 2009

(54) AUDIO/VIDEO APPARATUS AND CONTROL METHOD OF THE SAME

(75) Inventor: ZONG-SONG YANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/118,941

(22) Filed: May 12, 2008

(30) Foreign Application Priority Data
Aug. 30, 2007 (CN) 200710201543.X

(51) Int. Cl. H04N 5/225

(52) U.S. Cl. 348/220.1; 348/E07.001

(57) ABSTRACT

An audio/video apparatus includes a sensor for sensing vital signs of a human body and outputting a signal corresponding to the vital signs, a physiological parameter detector for generating a physiological parameter according to the signal outputted by the sensor, an analyzing unit for analyzing whether the physiological parameter generated by the detector is within a preset range, a playing module for playing an audio/video content, and a play controller for controlling whether the playing module plays the audio/video content according to an analysis result of the analyzing unit.

### TECHNICAL FIELD

The present invention relates to an audio/video apparatus, particularly to an audio/video apparatus capable of detecting vital signs of a human body and a play control method of the audio/video apparatus.

### DESCRIPTION OF RELATED ART

Audio/video (A/V) apparatuses, such as digital cameras, MP3s, MP4s, and game machines, are widely used. However, fatigue, stress, and accidents caused by using such apparatuses for extended periods of time or in unhealthy locations, and/or the viewing of morbid or overly exciting content have been known to cause physiological changes in a user that can be dangerous, particularly to those with pre-existing conditions such as heart disease and have even resulted in death.

### SUMMARY

In accordance with one present embodiment, an audio/video apparatus includes a sensor for sensing vital signs of a human body and outputting a signal corresponding to the vital signs, a physiological parameter detector for generating a physiological parameter according to the signal outputted by the sensor, an analyzing unit for analyzing whether the physiological parameter generated by the detector is within a preset range, a playing module for playing an audio/video content, and a play controller for controlling whether the playing module plays the audio/video content according to an analysis result of the analyzing unit.

In accordance with one present embodiment, a play control method of an audio/video apparatus includes playing audio/video content, detecting a physiological parameter of a user, judging whether the detected physiological parameter is outside a preset range, and controlling whether to play an audio/video content according to a judging result of whether the detected physiological parameter is outside the preset range.

### BRIEF DESCRIPTION OF THE DRAWING

Many aspects of the present A/V apparatus can be better understood with reference to the following drawings. The components in the drawing are not necessarily drawn to scale, the emphasis instead being placed upon clearly illustrating the principles of the present A/V apparatus. Moreover, in the drawings, like reference numerals designate corresponding parts throughout the several views.

FIG. 1 is an isometric view of an audio/video apparatus according to a present embodiment.

FIG. 2 is a plan view of the audio/video apparatus of FIG. 1.

FIG. 3 is a functional block diagram of the audio/video apparatus of FIG. 1.

FIG. 4 is a flow chart of a control method of the audio/video apparatus of FIG. 1.

### DETAILED DESCRIPTION OF THE EMBODIMENTS

Embodiments will now be described in detail below, with reference to the drawings.

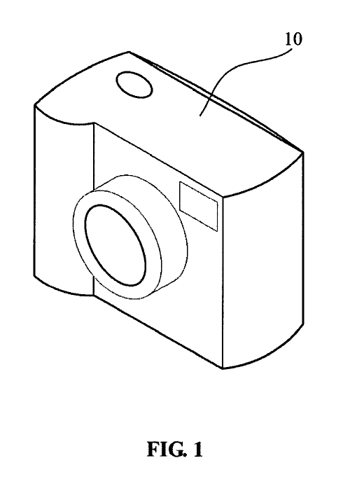

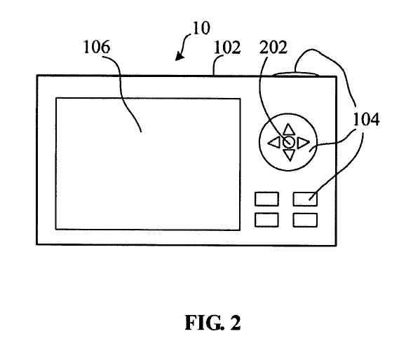

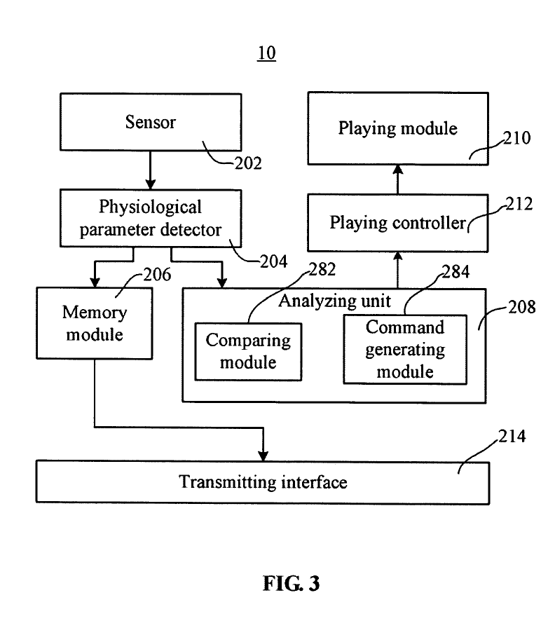

Referring to FIGS. 1-3, FIG. 1 is an isometric view of an audio/video apparatus 10 according to a present embodiment, FIG. 2 is a plan view of the audio/video apparatus 10 of FIG. 1, and FIG. 3 is a functional block diagram of the audio/video apparatus 10 of FIG. 1.

The audio/video apparatus 10 includes a casing 102, a sensor 202, a physiological parameter detector 204, a memory module 206, an analyzing unit 208, a playing module 210, a play controller 212, and a transmitting interface 214.

The casing 102 has a plurality of buttons 104 and a screen 106 disposed thereon. By operating the buttons 104, users can operate the audio/video apparatus 10 to achieve some functions, such as capturing an image or viewing photos stored in the audio/video apparatus 10. The screen 106 is configured for displaying photos and videos.

Preferably, the sensor 202 is disposed on the buttons 104. The sensor 202 is configured for sensing vital signs of a user and outputting a signal corresponding to the vital signs. It is understood that, the sensor 202 also can be disposed anywhere on the casing 102 where a user's hands or fingers can contact as well. The vital signs can include, but are not limited to, body temperature, heart rate, and so on.

The physiological parameter detector 204 is configured for generating a physiological parameter corresponding to the signal outputted by the sensor 202.

The memory module 206 is configured for storing the physiological parameter generated by the detector 204. The memory module 206 can also be used for storing a preset range of the physiological parameter. If the physiological parameter of a user is outside the preset range, the user may be in danger. That is, the preset range relates to a health index.

The analyzing unit 208 is configured for analyzing whether the physiological parameter generated by the detector is within the preset range and outputting a control signal accordingly. The analyzing unit 208 includes a comparing module 282 and a command generating module 284. The comparing module 282 is configured for comparing the physiological parameter generated by the detector 204 with the preset range. The command generating module 284 is configured for generating a stop signal when the physiological parameter generated by the detector 204 is outside the present range.

The playing module 210 is configured for playing an audio/video content of the A/V apparatus 10.

The play controller 212 is configured for controlling whether the playing module 210 plays the audio/video content according to an analysis result of the analyzing unit 208, such as stopping the playing module 210 when received the stop signal from the command generating module 284.

The transmitting interface 214 is configured for connecting the A/V apparatus 10 to a peripheral apparatus, such as a computer, and outputting the detected physiological parameter.

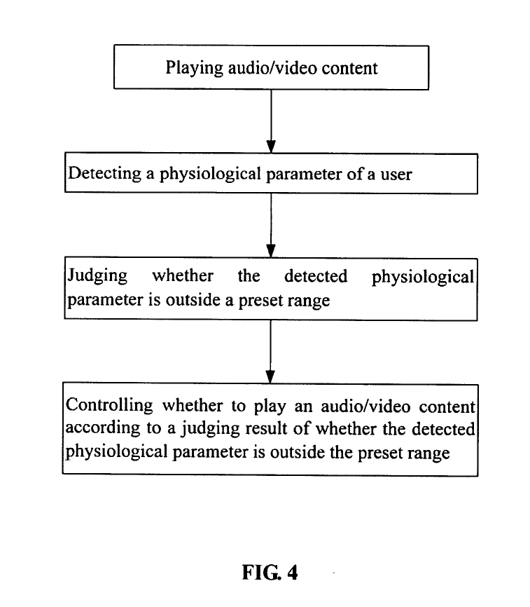

Referring to FIG. 4, FIG. 4 is a flow chart of a control method of the audio/video apparatus 10 of FIG. 1. A play control method of the audio/video apparatus 10 is also provided. The method includes the steps of: playing audio/video content; detecting a physiological parameter of a user; judging whether the detected physiological parameter is outside a preset range; stopping playing of A/V content, if the detected physiological parameter is outside the preset range.

The audio/video apparatus 10 can detect physiological parameter of users and stop operation of the audio/video apparatus 10 when the user's physiological parameter indicates the user is in distress. In other embodiments, the audio/video apparatus may use visual or audible alarms to alert the user or passersby, or even communicate wirelessly for calling for help.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An audio/video apparatus comprising:
a sensor for sensing vital signs of a human body and outputting a signal corresponding to the vital signs;
a physiological parameter detector for generating a physiological parameter according to the signal outputted by the sensor;
an analyzing unit for analyzing whether the physiological parameter generated by the detector is within a preset range;
a playing module for playing an audio/video content; and
a play controller for controlling whether the playing module plays the audio/video content according to an analysis result of the analyzing unit.

2. The Audio/Video apparatus as claimed in claim 1, further comprising a casing with at least one button disposed thereon, and the sensor being disposed on the button.

3. The audio/video apparatus as claimed in claim 1, further comprising a casing, and the sensor being disposed on the casing.

4. The audio/video apparatus as claimed in claim 1, wherein the vital signs are selected from a group consisting of temperature and heart rate.

5. The audio/video apparatus as claimed in claim 1, further comprising a memory module for storing the preset range.

6. The audio/video apparatus as claimed in claim 1, further comprising a transmitting interface for connecting to a peripheral apparatus and outputting the physiological parameter generated by the detector to the peripheral apparatus.

7. A play control method of an audio/video apparatus, comprising:
playing audio/video content;
detecting a physiological parameter of a user;
judging whether the detected physiological parameter is outside a preset range; and
controlling whether to play an audio/video content according to a judging result of whether the detected physiological parameter is outside the preset range.

8. The method as claimed in claim 7, wherein controlling whether to play the audio/video content according to the judging result of whether the detected physiological parameter is outside the preset range comprises stopping playing the audio/video content when judging the detected physiological parameter is outside the preset range.

9. The method as claimed in claim 7, further comprising sensing vital signs of the user and generating the physiological parameter according to the vital signs.10. The method as claimed in claim 9, wherein the vital signs are selected from a group consisting of temperature and heart rate.
